(19) United States
(12) Patent Application Publication
(10) Pub. No.: US 2004/0142089 A1
(43) Pub. Date: Jul. 22, 2004

(54) Beans paste, the method for preparation thereof and processed food

(75) Inventor: Masanori Hisatomi, Tokushima-shi (JP)

Correspondence Address: CHAPMAN AND CUTLER, 111 WEST MONROE STREET, CHICAGO, IL, 60603, US

(73) Assignee: Isyokudougensya Co., Ltd., Tokushima (JP)

(21) Appl. No.: 10/447,937

(22) Filed: May 29, 2003

(30) Foreign Application Priority Data
May 31, 2002 (JP) 2002-158552

(51) Int. Cl. A23L 1/36

(52) U.S. Cl. 426/629

(57) ABSTRACT

The present invention is about; the beans paste, which is rich in nutrients, doesn't lose its flavor, can be put to wide use, can be made into homogeneous paste and can be produced directly from beans:

the method for preparation of the beans paste, which effectively produces beans paste directly from beans with easy procedure:

the processed food, which uses the said beans paste and alternates the existing confectionary and food that uses eggs.

The said beans paste is made by grinding beans as raw materials, which is made to contain water molecules about 75˜95 weight % against the gross weight of ingredients of beans and water contained in beans, and the processed food is produced by using soybeans paste which is made by the method as described above.

### BACKGROUND OF THE INVENTION

(1) Field of the Invention

The present invention is related to beans paste, method for preparation thereof and processed food, particularly to the beans paste that can be directly produced from beans such as soybeans with simple procedure; the method for Preparation thereof; the processed food, mayonnaise related food for example, which is made from the said beans paste and has satisfactory flavor and texture.

(2) Related Art Statement

It is necessary to control intake of cholesterol and reduce intake of the food that contains the ingredients of animal products such as eggs if someone has an allergy to these ingredients.

The method for making paste from bean curd refuse is stated in some cases such as Japanese Provisional Publication NO. 266240/1996 and Japanese Provisional Publication Official gazette No.99037/1998. In particular, Japanese Provisional Publication NO.266240/1996 discloses the method for mixing warm water and seasoning into bean curd refuse, grinding down by friction and making paste from it.

However, because bean curd refuse itself is the residuum, which is squeezed from soymilk that contains high nutrition such as protein and fat, it has the disadvantage that it is poor in nutrients, the flavor of it gets deteriorated and the dry texture remains even after it is made into paste.

In addition, the paste of it is not produced directly from beans, but produced from bean curd refuse and therefore, the process of producing paste is complicated as it has to go through the process of producing been curd refuse.

Also, Japanese Provisional Publication Official gazette No.99037/1998 discloses the method for preparation of soybeans food materials by soaking and heating soybeans in heated water that is added alkalis, which exuviated the skin and removed the hypocotyl, substantially without being swollen by absorbing water, and crushing it under given condition.

According to this method, it can be expected to produce processed food with high nutrition because most part of soybeans can be used. However, the method for preparation gets complicated because the process of exuviating the skin and removing the hypocotyl is necessary. Further, soybeans food material produced by crushing is mostly used for food such as beans jam(an in Japanese) and mashed potatoes and in case it is used for mayonnaise related food as an alternative of eggs, it is essential to add emulsifying agent, such as increasing-viscosity polysaccharides, oligosaccharide, lecithin, fatty acid monoglyceride, fatty acid poli-glyceride, saccharose fatty acid ester, and sorbitan fatty acid ester as emulsification ability of these soybeans food material is lower compared to egg yolk.

On the other hand, Japanese Provisional Publication NO.119260/2002 discloses the method for producing alternative egg processed food without using eggs; in particular, the method for preparation of scrambled egg related food is stated. Also, the method for preparation of mayonnaise related food using condensed tofu is stated in Japanese Provisional Publication NO.17292/2002.

However, the processed food, which uses beans paste produced directly from beans is not disclosed and moreover, there is not even any suggestion about mayonnaise related food. There hasn't been any method for producing the mayonnaise related food that uses beans paste until today.

The present invention is to overcome the above problems and provide the beans paste, which is rich in nutrients, doesn't lose its flavor, can be put to wide use, can be made into homogeneous paste and can be produced directly from beans.

Also, the other object of the present invention is related to the method for preparation of beans paste, which effectively produces beans paste directly from beans with easy procedure.

In addition, the other purpose of the present invention is related to the processed food, which uses the said beans paste and alternates the existing confectionary and food that uses eggs.

### SUMMARY OF THE INVENTION

The present inventors have found out that, as a result of studies to overcome the above problems, it is not enough only to soak and swell beans in water but, by making beans contain the given weight rate of water, it is possible to produce homogeneous paste directly from the said beans containing water and the said paste has emulsification ability that is similar to egg yolk and finally succeeded in the present invention.

The invention related to claim 1 is the beans paste, which is made by grinding the beans as raw material, which is made to contain water molecules about 75˜95 weight % against the gross weight of the ingredients of beans and water contained in beans.

The invention related to claim 2 is the beans paste as claimed in claim 1, wherein the percentage of water content is 88˜92 weight %.

The invention related to claim 3 is the beans paste as claimed in claim 1 or 2, wherein the said beans is soybeans.

The invention related to claim 4 is the method for preparation of the beans paste of claim 1 to 3, which comprises making beans contain 75˜95 weight % of water content, and then, grinding the said beans and processing them to paste.

The invention related to claim 5 is the method for preparation of the beans paste as claimed in claim 4, wherein the method fur making beans contain water molecules includes the process of crushing the swollen beans.

The method for preparation of the beans paste as claimed in claim 5, wherein the method for making beans contain water molecules includes the process of crushing beans, soaking the crushed beans in water and heating and/or pressurizing the said beans in the water.

The processed food, which uses the beans paste of claim 1 to 3.

The processed food, which uses the beans paste produced by the method for preparation the beans paste as claimed in claim 4 to 6.

The processed food as claimed in claim 7 or 8, which is mayonnaise related food.

### DETAILED DESCRIPTION OF THE INVENTION

The favorable examples of the present invention will be explained hereinafter but these are not everything. The beans paste of the present invention is made by grinding the beans as raw material, which is made to contain water molecules about 75˜95 weight %, 80˜92 weight % in favorable, 88˜92 weight % in the most favorable, against the gross weight of the ingredients of beans and water contained in beans.

If water content is less than 75 weight %, homogenous paste cannot be produced even it the beans is processed by grinding. On the other hand, if water content is more than 92 weight %, liquidity is increased, the self-shape retention ability is lost and therefore, it is impossible to make paste condition.

Here, “paste” means viscosity that can retain the shape by itself. For example, in case of measuring the viscosity with B type rotating viscometer, it has to be 10000˜400000 mPa·s viscosity.

The beans that can be used in the present invention are optional beans, such as pinto bean, azuki bean, kintoki bean, broad bean, sugar peas, sasage, kidney bean, and soybeans.

Normally, water content of dried beans, for example, is about 10 weight % and even if the beans is soaked and swollen in water for a day, the water content rises only to 70 weight %. Even if the beans with such level of water content is grinded, it is impossible to produce paste directly from the said beans.

In order to produce paste directly by grinding the beans, the amount of water in beans is the extremely essential element. Particularly, it is necessary that the amount of water in beans is around 75˜95 weight %, 80˜92 weight % in favorable, 88˜92 weight % in the most favorable. That is to say, only the beans which contains the above stated amount of water can be used for producing paste by the direct process.

In one example of the present invention, it is possible to raise the amount of water to the above stated level of the present invention by grinding the normal beans directly, which is not soaked in water and in dry condition, making grained beans, adding water to the said grained beans and then, heating and pressurizing it if required. The method for soaking the said grained beans in water or adding water with grinding beans can be also used instead of the said method for adding water to the said grained beans. In addition, by heating and pressurizing, it is possible to reduce the time for adjusting water content into the above stated level of the present invention.

In another example of the present invention, in order to raise water content of beans, it is preferable to soak and swell beans in water, crush it once and make coarse grained beans, add water to the said grained beans again, then heat and pressurize it if required and raise water content to 75 ˜95 weight %. The above stated method can be used as the method for adding water to the said grained beans.

In this case, cellular tissue of beans is not destroyed and nutrient element of cellular tissue doesn't flow out to water and therefore, it is possible to produce the beans paste that is rich in nutrients. Moreover, it enables controlling water content of beans within the given level and getting the expected beans paste easily, by using the osmotic pressure effect of cell membrane.

More specifically, in the above stated example, it is possible to form fine grain condition without destroying cellular tissue of beans by swelling beans and crushing it that is added the flexibility in it. As the grained beans, which is aggregate of plural cellular tissues, has dramatically more surface area per unit volume compared to the one that is not grained, it absorbs more water and ensures the given amount of water contained in it.

As stated above, it is possible to produce beans paste directly from beans by grinding the beans that is made to contain about 70˜95 weight % of water molecules. Grinding process is the process that destroys the form of beans by grinding down by fraction in order to release water-soluble polysaccharides inside beans. By this grinding process, water-soluble polysaccharides in beans is released and, with hydration of this, it is possible to produce the beans paste of the present invention with viscosity directly from beans.

In the present invention, as the beans paste of this condition has appropriate viscosity and self-shape retention ability, it is not only easy to be used for cooking but also, has appropriate texture and flavor. Therefore, it is in the optimum condition as an ingredient.

In addition, the beans paste of the present invention has the emulsification ability that is similar to egg yolk. The reason of emulsification ability increase is thought to be that the water-soluble polysaccharides included in dietary fiber of beans is released outside by the grinding process, and then it increases the emulsification ability of lecithin in beans. Herewith, in case the beans paste is used for processed food such as mayonnaise related food, for example, it can provide the processed food that is more suitable to healthy oriented, as it can alternate egg yolk and there is no need to add emulsifying agent such as increasing-viscosity polysaccharides, or even in case of adding emulsifying agent, it is necessary to add only less amount.

The processed foods related to the present invention are various processed foods such as mayonnaise related food, ice cream, and cake as the beans paste of the present invention can be an alternative of eggs. Particularly, as the beans paste of the present invention has the emulsificion ability that is similar to egg yolk, it can completely demonstrate the character of the present invention in the processed food, such as mayonnaise related food that are in emulsion condition.

As the specific example of the processed food of the present invention, the practical examples of the mayonnaise related food are described as follows.

Here, mayonnaise related food means a notion that includes the semi-solid dressing or the emulsifying liquid dressing such as mayonnaise, salad dressing, French dressing, spread, and tartar sauce.

The present invention can produce the emulsification food, i.e. mayonnaise related food, by using the beans paste of the present invention instead of egg yolk and adding and mixing the vinegar and edible oil to the beans paste.

In addition, seasoning such as salt, spices, liquid sugar, viscosity increasing stabilizer and water can be mixed if required. In case of using these additives, as for viscosity increasing stabilizer, for example, it is spread and dissolved in water in advance and the water, in which the viscosity-increasing stabilizer is spreading, is added and mixed to the mixture of seasonings and sugar and beans paste. The emulsification food can be produced by adding edible oil by using the mixing instrument such as mixer, for example and emulsifying it.

In addition, it is possible to produce mayonnaise related food, by mixing and agitating water phase part such as vinegar, seasoning and spice, or water phase part that is added water, for example, with continuous mixer, mixing the said beans paste to it, mixing edible oil and then, stirring it with colloid mill and sterilizing it by heating.

Although it is necessary to add viscosity increasing stabilizer to the above described mayonnaise related food, this process is not necessary here.

It is possible to regulate the mixing rate of vinegar, soybeans paste and edible oil according to the utilization purpose of the mayonnaise related food of the present invention, such as texture, flavor, taste and emulsification condition. In particular, the preferable composition rate of essential ingredients (soybeans paste, edible oil, edible vinegar) in case of producing the mayonnaise related food by the beans paste of the present invention is as follows.

| | |
|---|---|
| Edible vinegar | 4˜35 weight % |
| Soybeans paste | 5˜45 weight % |
| Edible oil | 30˜85 weight % |

In addition, as edible vinegar, fruit vinegar such as apple vinegar, rice vinegar, alcohol vinegar, lees vinegar, black vinegar, wine vinegar, balsamic vinegar can be given as examples.

Also, as edible oil, vegetative fat such as soybeans oil, cotton oil, corn oil, sesame oil, safflower oil, colza oil, olive oil, rice oil, grape oil, peanut oil, thistle saffron oil, palm oil, and salad oil or animal fat can be given as examples.

Further, as the above said seasonings that can be used for the present invention, sugar, glucose, fructose, or the mixture sugar of them, sweetener such as starch syrup, salt, acidifier such as citric acid, and chemical seasonings are included.

Emulsification of water phase part and oil phase part can be done by mixer, collide mill, paddle mixer, homogenizer, agitator and other emulsifying instruments within the public domain.

The processed food that uses the beans paste of the present invention is the healthy emulsification food, which can avoid cholesterol contained in egg yolk and the problem of egg allergy, is low in fat and calories and moreover, it controls the smell and bitter taste that is peculiar to soybeans and equips rich flavor and full-bodied taste.

The present invention will be further explained hereinafter with reference to Examples. Followings will define more clearly the effectiveness of the present inventions by using the practice examples. However, the technical scope of the present invention is not limited to those practice examples.

Practice examples use soybeans as beans.

### PRACTICE EXAMPLE 1˜6

<Soybeans Paste>

Soybeans 10 kg was soaked in sufficient quantities of water and left at rest for 8˜10 hours in room temperature.

Then, it was grained by an abrasive cut-off machine (made by Stephan corporation, Germany) which is a crushing machine and the grained beans about 3˜8 mm at the average size was made from it.

Further, the soybeans, the water content of which is indicated in table 1 was made by adding the 90° C. heated water to the 20 Kg of said grained beans and the beans paste of the present invention, the viscosity of which is indicated in table 1 was made by using grinder-crushing machine (trade name: CERENDIPITOR by Masuko industry Co Ltd.,) and grinding fully with condition of 0.05 mm clearance between grind stone of the said grinder-crushing machine and 2500˜3000 rpm rotation.

### COMPARATIVE EXAMPLE 1

After soaking 10 kg soybeans in sufficient quantities of water, leaving it at rest for 8˜10 hours in room temperature and making it contain 68.2 weight % of water content, the said soybeans was grinded by using the same grinder-crushing machine as practice example 1. However, it wasn't made into paste condition and powdery things were left.

### COMPARATIVE EXAMPLE 2

By the same method as practice example 1, the grinding process was done by using the soybeans with 98.0 weight % of water content. However, the thing that was made by the method didn't have self-shape retention ability and was almost in liquid condition.

### EXAMINATION EXAMPLE 1

Water content of the soybeans, which was used in practice example 1˜6 and comparative example 1, 2 and the viscosity characteristics of the beans paste produced from the said soybeans are measured by the following method.

Water content was measured by using atmospheric pressure ustulation method.

Viscosity characteristics was measured in the 25° C. environment temperature, by rotating the No.4 rotor at 12 rpm rotating speed by B type rotating viscometer. However, it was impossible to measure comparative example 1 and 2 as paste could not be produced.

Emulsification ability was measured by inspecting the condition after being left at rest for 60 days in 5° C. The one that resulted in a separation of oil and water layer is indicated with X and the one that resulted in retention of emulsification condition without a separation is indicated with ∘. However, it was impossible to measure comparative example 1 and 2 as paste could not be produced.

Flavor and texture was judged by ⊚ (most favorable), ∘ (favorable) and X (least favorable) in respect of the smell without peculiar smell and homogeneous smoothness.

### MEASUREMENT RESULT

The measurement result is indicated in table 1.

TABLE 1

| | Water | | | |
|---|---|---|---|---|
| | component | | | |
| | percentage | Viscosity | Emulsification | Taste/ |
| | (weight %) | (mP · s) | ability | Texture |
| Working example 1 | 85.6 | 12,600 | ◯ | ◯ |
| Working example 2 | 82.7 | 11,000 | ◯ | ◯ |
| Working example 3 | 78.2 | 10,500 | ◯ | ◯ |
| Working example 4 | 91.4 | 15,700 | ◯ | ⊚ |
| Working example 5 | 90.8 | 23,300 | ◯ | ⊚ |
| Working example 6 | 90.1 | 36,000 | ◯ | ⊚ |
| Comparative | 68.2 | — | X | X |
| example 1 | | | | |
| Comparative | 98.0 | — | X | X |
| example 2 | | | | |

From the measurement result, in working example 1˜6 related to the present invention, emulsification ability, taste and texture were better comparing to comparative example 1 and 2. The fact that water content of the beans paste, before being grinded, is 75˜95 weight % is thought to contribute largely to this result.

In addition, practice example 4˜6 especially, out of practice example 1˜6, where water content of beans paste is 88˜92%, had the good result with emulsification ability, taste and texture. Further, in practice example 4˜6, the self-shape retention ability was excellent and texture such as mouthfeel was the most preferable thing.

### PRACTICE EXAMPLE 7˜12, COMPARATIVE EXAMPLE 3, 4

<Processed food>

Soybeans paste as beans paste of the above stated practice example 1˜6, comparative example 1, 2 was used for producing mayonnaise related food. The blending ratio is stated as follows.

| | |
|---|---|
| Edible oil (soybeans oil) | 55 part by weight |
| Edible vinegar (apple vinegar) | 6 part by weight |
| Seasonings (chemical seasoning) | 1.3 part by weight |
| Salt | 1.5 part by weight |
| Liquid sugar (sugar/fructose | 2 part by weight |
| glucose liquid sugar) | |
| Soybeans paste | 10 part by weight |
| Viscosity increasing stabilizer | 0.4 part by weight |
| (xanthan gum) | |
| Water | 8 part by weight |

The mayonnaise related food of the present invention was made by spreading the above said viscosity increasing stabilizer in water, adding and kneading it into the mixture of beans paste, seasonings, salt, and liquid sugar, then putting it in a mixer and dropping the edible oil with kneading and making it emulsified.

### EXAMINATION EXAMPLE 2

Table 2 shows the measurement result, by the same method as examination example 1, of the viscosity characteristic and the taste of mayonnaise related food, which is related to practice example 7˜12 and comparative example 3.

However, mayonnaise related food, which is made by using soybeans of comparative example 3, got emulsified instantaneously, but separated in about 5 minutes at room temperature and could not retain the emulsification condition. Also, it was impossible to produce mayonnaise related food by using the soybeans of comparative example 4.

TABLE 2

| | Viscosity | Emulsification | Taste/ |
|---|---|---|---|
| | (mPa · s) | ability | Texture |
| Working example 7 | 180,000 | ◯ | ◯ |
| Working example 8 | 170,000 | ◯ | ◯ |
| Working example 9 | 130,000 | ◯ | ◯ |
| Working example 10 | 210,000 | ◯ | ⊚ |
| Working example 11 | 260,000 | ◯ | ⊚ |
| Working example 12 | 280,000 | ◯ | ⊚ |
| Comparative | 30,000 | — | X |
| example 3 | | | |
| Comparative | — | — | X |
| example 4 | | | |

As explained above, the beans paste of the present invention is rich in nutrients, doesn't lose its flavor, can be put to wide use, can be made into homogeneous paste.

Also, the method for preparation of the beans paste has high production efficiency as it can produce beans paste directly from beans with easy procedure.

In addition, as the beans paste of the present invention has similar emulsification ability to egg yolk, it can produce the processed food that alternates the existing confectionary and food using eggs. Particularly, it can be favorably used for the processed food, such as mayonnaise related food, which is in emulsion condition.

1. The beans paste, which is made by grinding beans as raw materials, which is made to contain water molecules about 75˜95 weight % against the gross weight of ingredients of beans and water contained in beans.

2. The beans paste as claimed in claim 1, wherein the percentage of water content is 88˜92 weight %.

3. The beans paste as claimed in claim 1 or 2, wherein the said beans is soybeans.

4. The method for preparation of the beans paste of claim 1 to 3, which comprises making beans contain 75˜95 weight % of water content, and then, grinding the said beans and processing it to paste.

5. The method for preparation or the beans paste as claimed in claim 4, wherein the method of making beans contain water molecules includes the process of crushing the swollen beans.

6. The method for preparation of the beans paste as claimed in claim 5, wherein the method of making beans contain water molecules includes the process of crushing beans, soaking the crushed beans in water and heating and/or pressurizing the said beans in the water.

7. The processed food, which uses the beans paste of claim 1 to 3.

8. The processed food, which uses the beans paste produced by the method for preparation of the beans paste of claim 4 to 6.

9. The processed food as claimed in claim 7 or 8, which is mayonnaise related food.
